(19) United States
(12) Patent Application Publication
(10) Pub. No.: US 2026/0262651 A1
(43) Pub. Date: Sep. 10, 2026

(54) COPPER OXYCHLORIDE/ZINEB NANO-SUSPENSION DISPERSION

(71) Applicant: Ziyong ZHANG, Nanjing (CN)

(72) Inventors: Ziyong ZHANG, Nanjing (CN); Bing LIANG, Nanjing (CN)

(73) Assignee: Ziyong ZHANG, Nanjing (CN)

(21) Appl. No.: 19/664,084

(22) Filed: Apr. 30, 2026

Related U.S. Application Data
(63) Continuation of application No. PCT/CN2024/129529, filed on Nov. 2, 2024.

(30) Foreign Application Priority Data
Nov. 2, 2023 (WO) PCT/CN2023/129390
May 15, 2024 (WO) PCT/CN2024/093421

(51) Int. Cl. A01N 59/20; A01N 25/04; A01N 55/02; A01P 3/00

(52) U.S. Cl. CPC A01N 59/20; A01N 25/04; A01N 55/02; A01P 3/00

(57) ABSTRACT

The present invention belongs to the field of nano-pesticides, and particularly relates to the preparation of suspension dispersions of pesticide varieties insoluble in water and solvents, with a microparticle size of less than 100 nanometers. The copper oxychloride/zineb nano-suspension dispersion is a nano-suspension wherein copper oxychloride and zineb microparticles are dispersed in a random coil morphological structure formed by a water-soluble polymeric dispersant in water.

### CROSS-REFERENCE TO RELATED APPLICATIONS

This application is the U.S. national phase of International Application No. PCT/CN2024/129529 filed on 2 Nov. 2024 which designated the U.S. and claims priority to Chinese Application No. PCT/CN2023/129390 and PCT/CN2024/093421 filed on 2 Nov. 2023 and 15 May 2024, respectively, the entire contents of each of which are hereby incorporated by reference.

### TECHNICAL FIELD

The present invention belongs to the field of nano-pesticides, and particularly relates to the preparation of compounded suspension dispersions of inorganic copper and zinc-containing compounds that are insoluble in water and solvents, with a microparticle size of less than 100 nanometers.

### BACKGROUND TECHNOLOGY

Modern agricultural production must utilize pesticides. Improving the formulation performance of existing pesticide varieties, increasing efficacy, reducing pesticide usage, and mitigating environmental impacts are of great significance for sustainable agricultural development.

An effective approach to achieving pesticide reduction is to significantly decrease the microparticle size of the active ingredients in pesticide formulations. For water-insoluble pesticides, reducing to the minimum size means a few nanometers. Nano-pesticides refer to formulations where the pesticide microparticle size is on the nanoscale (1 to 100 nm). The microparticle size of traditional pesticide formulations is on the micrometer scale, ranging from a few micrometers to tens of micrometers or even larger. If the microparticle size is reduced to the nanometer scale, shrinking by a factor of a thousand, theoretically, the number of microparticles can increase a billionfold, and the surface area can increase a thousandfold. The dramatic increase in the number and surface area of pesticide microparticles allows for more uniform dispersion on leaves and broader contact with targets, enabling the efficacy to be fully exerted and enhanced.

On Apr. 1, 2019, the International Union of Pure and Applied Chemistry (IUPAC), on the occasion of its 100th anniversary, announced the “Top Ten Chemical Innovations That Will Change the World,” with “nano-pesticides” ranking first. The reason is that, based on continuous global population growth, it is predicted that the world population will approach 10 billion by 2050. To feed such a massive population, it is necessary to significantly increase agricultural yields while minimizing the environmental impact caused by land use, including reducing pesticide pollution and water usage. Nano-pesticides, with their small microparticle sizes and better target absorption, will be an excellent tool to solve the main problems of traditional pesticides (environmental pollution, pesticide accumulation in organisms, and significant increases in pest resistance). Although it cannot be said to be the only path for sustainable agricultural development, it is certain that its impact on the ecological environment and human health is much smaller, making the earth more sustainable.

Dicopper chloride trihydroxide, commonly known as copper oxychloride (Wangtong in Chinese), or basic copper chloride, is a pale green powdery substance, and it is an inorganic copper compound that can have multiple structures. The active ingredient is copper oxychloride, and the typical chemical structure is:

CuCl₂·3Cu(OH)₂

As an ancient and effective pesticide, it is an important copper formulation along with Bordeaux mixture, copper hydroxide, etc. Since the early 20th century, it has been widely used in agricultural disease prevention. Its history of use is closely related to the development of copper-based fungicides, which are widely applied globally due to their broad spectrum, high efficacy, and relative safety.

This compound, copper oxychloride, has an inhibitory and lethal effect on a variety of plant pathogens. It mainly prevents and controls crop diseases through contact action, meaning it must be directly applied to the plant surface, inhibiting the growth and reproduction of pathogens by destroying their cell walls or interfering with their physiological processes. Copper oxychloride is particularly suitable for preventing and controlling fungal and bacterial diseases in various crops, such as grape downy mildew, apple scab, and late blight of tomatoes and potatoes. These diseases are widespread in agricultural production and, if not effectively controlled, will seriously affect crop yield and quality.

In addition to being used alone, copper oxychloride can also be mixed with other pesticides to improve control efficacy or expand the prevention spectrum. For example, mixing it with dithiocarbamates, triazoles, prochloraz, and other fungicides can enhance the control capability against a series of fungal diseases. However, it is important to note that not all pesticides can be safely mixed with copper oxychloride, and one must avoid using pesticides that chemically react with it or reduce its efficacy.

In summary, copper oxychloride, as a copper-based fungicide with a long history, still plays an important role in modern agricultural production. Through rational use and integration with other prevention and control measures, crop health can be effectively protected, increasing the sustainability of agricultural production.

### SUMMARY OF THE INVENTION

### Objectives of the Present Invention

One of the objectives of the present invention is to overcome the deficiencies of existing technologies and provide an innovative idea and technical method distinct from existing copper oxychloride formulation preparation techniques—the preparation of a copper oxychloride nano-suspension dispersion. The preparation of traditional copper oxychloride formulations involves using copper chloride and calcium hydroxide to generate copper oxychloride. Because calcium hydroxide has low solubility in water, and the generated product copper oxychloride has an extremely low solubility in water (solubility of 5.06×10⁻⁴ g/L at pH 6.5, 20° C.), a copper oxychloride precipitate is obtained. This is used as the technical material to further process into copper oxychloride formulations—wettable powders, suspension concentrates. The innovative idea and technical method of the present invention involves using copper chloride and a water-soluble alkali, through a solution reaction and by controlling reaction conditions, directly obtaining a nano-suspension dispersion of copper oxychloride.

Another objective of the present invention is, in order to improve the prevention and control efficacy of copper oxychloride, expand the fungicidal spectrum, grant it a synergistic effect, and reduce the dosage of a single variety, to compound it with a highly efficient, low-toxicity, broad-spectrum carbamate protective organosulfur fungicide, zineb. Thus, while obtaining the copper oxychloride nano-suspension dispersion, a zineb nano-suspension dispersion is also obtained; that is, obtaining a copper oxychloride/zineb nano-suspension dispersion simultaneously.

Another objective of the present invention is to reduce the microparticle size of copper oxychloride and zineb. Since copper oxychloride and zineb are insoluble in both water and organic solvents, current processing technology relies on mechanical crushing and grinding, which can only process them into traditional wettable powders and suspension concentrates. The microparticle sizes of these formulations are in the range of several to tens of micrometers, making it difficult to improve their efficacy. The copper oxychloride/zineb nano-suspension dispersion prepared by the present invention has a microparticle size of less than 100 nm, dramatically reducing the microparticle size, thus significantly improving the efficacy of the compounded copper oxychloride/zineb formulation.

Yet another objective of the present invention is to shorten the technical material production and formulation processing workflow for copper oxychloride and zineb. Commercially, original pesticide manufacturers first produce the copper oxychloride and zineb technical materials, and then formulation plants process them into copper oxychloride/zineb compounded formulations. The present invention directly utilizes the synthesis of copper oxychloride and zineb, taking advantage of the pesticide water dilution process and controlling the reaction conditions to obtain a transparent copper oxychloride/zineb nano-suspension dispersion. This method integrates the synthesis and formulation processing of copper oxychloride and zineb, directly eliminating the technical material synthesis and purification processes, the formulation processing operations, and the associated expensive production equipment, with no wastewater generated during the process, achieving significant environmental protection and energy-saving effects.

A further objective of the present invention is to provide a copper oxychloride/zineb nano-suspension dispersion that can be directly used for spraying. According to the volume of dilution water and the amount of product generated, it is adjusted to a spray concentration suitable for crops, and spraying operations are performed directly after preparation. Since the pesticide microparticle size is less than 100 nm, efficacy is significantly improved, reducing pesticide usage and contributing to sustainable agricultural development.

### INNOVATIVE CONCEPTS OF THE PRESENT INVENTION

### Distinct Performance Characteristics of Copper Oxychloride and Zineb

Performance Characteristics of Copper Oxychloride: Broad fungicidal spectrum. It is effective against a variety of fungal and bacterial diseases, such as canker, bacterial leaf spot, yellow spot, snake eye disease, wilt, scab, sooty mold, anthracnose, angular leaf spot, etc. It is particularly outstanding in preventing and controlling bacterial diseases, effectively addressing disease issues caused by bacterial infections in crops. Good mixability. It can be mixed with many fungicides and insecticides, which can expand the prevention scope and improve efficacy. Resistance to rain wash. Spraying it on crop surfaces forms a copper film; this film not only prevents pathogen invasion but also has good resistance to rain wash, maintaining strong control efficacy even after rainy weather, reducing efficacy loss caused by rain. Relatively high safety. Among copper formulations, copper oxychloride is relatively safe with low phytotoxicity. It has high crop safety, and under correct usage, it is unlikely to cause phytotoxicity, making it suitable for a variety of crops like citrus, lychee, grapes, tomatoes, cucumbers, etc. Growth-stimulating effect. When used on crops like potatoes, peanuts, sunflowers, etc., it has growth-stimulating and yield-increasing effects; while controlling diseases, it also promotes crop growth and development, improving yield and quality.

Performance Characteristics of Zineb: Broad fungicidal spectrum. It has good preventive effects against a variety of fungal diseases, useful for controlling downy mildew, early blight, late blight, anthracnose, leaf mold, rust, and other diseases on vegetables, cereals, grapes, tobacco, fruit trees, etc. It can effectively combat common fungal diseases on many crops, reducing disease damage. Strong protective nature. It is a protective fungicide, and its mechanism of action is to form a protective film on the plant surface to prevent pathogen entry, achieving disease prevention. Applying it before or at the early stage of disease onset can effectively protect crops from pathogen infection, reducing disease occurrence. Safe and non-polluting to plants. At normal use concentrations, zineb has no adverse effects on crop growth and development, leaves no residue inside plants, is environmentally friendly, and meets the development requirements of green agriculture. Convenient to use. It has good stability and does not decompose easily under conventional storage and usage conditions. Zinc supplementation. Zineb contains zinc elements; while controlling diseases, it can also supplement crops with zinc, helping improve nutritional status, promoting growth, and enhancing stress resistance.

### Performance Advantages of Compounding Copper Oxychloride and Zineb:

Broaden the fungicidal spectrum. Copper oxychloride is primarily effective against bacterial diseases, while zineb is effective against various fungal diseases. Compounding the two allows simultaneous control of both fungal and bacterial diseases, vastly expanding the fungicidal spectrum. It can effectively combat complex disease occurrences, reducing losses from incomplete single-disease treatments.

Enhance control efficacy. After compounding, fungicides with different action mechanisms work synergistically, enhancing the killing effect on pathogens. For hard-to-control diseases, such as mixed occurrences of stubborn fungal and bacterial diseases, it can improve control efficacy and reduce disease recurrence rates.

Delay resistance development. Because the two fungicides have different action mechanisms, it is difficult for pathogens to simultaneously develop resistance to both components. Long-term use of the compounded pesticide can delay pathogen resistance and extend the useful life of the pesticides.

Improve stability: Copper oxychloride decomposes easily in alkaline conditions, and zineb is also unstable under strongly alkaline conditions. Once compounded, they can mutually stabilize to a certain extent, improving the formulation's stability in various environmental conditions.

### Crops and Diseases Suitable for the Copper Oxychloride and Zineb Compounded Formulation

Fruit Trees. Apples: used to control fungal diseases like apple alternaria leaf spot, anthracnose, ring rot, and bacterial diseases like apple fire blight. Citrus: excellent efficacy against fungal diseases like citrus canker (bacterial), anthracnose, scab, etc. Pear trees: controls fungal diseases like pear scab, rust, and bacterial diseases like pear fire blight.

Vegetables. Cucumbers: controls cucumber downy mildew, bacterial angular leaf spot, etc. Tomatoes: used to control early blight, late blight, bacterial canker, etc. Eggplants: effective against eggplant Phytophthora blight, Verticillium wilt (fungal), and bacterial wilt.

Field Crops. Wheat: controls fungal diseases like wheat head blight, rust, and bacterial leaf streak. Rice: used to control fungal diseases like rice blast, sheath blight, and bacterial diseases like rice bacterial leaf blight. Corn: effective against fungal diseases like corn northern and southern leaf blight, and corn bacterial stalk rot.

Achieving the compounding of copper oxychloride and zineb, and preparing these two “insoluble in both water and organic solvents” pesticide varieties into a nano-pesticide compounded formulation-especially preparing them into a suspension dispersion with a size of less than 100 nm-will face immense technical challenges.

Generally, the mass ratio of the active ingredients of copper oxychloride to zineb might range from 1:2 to 2.5:1.

### 1. Technical Challenges Faced

The purpose of developing nano-pesticides is to solve the main problems of traditional pesticides-environmental pollution, pesticide accumulation in organisms, and the massive increase in pest and disease resistance. These all stem from outdated traditional formulations, large pesticide microparticle sizes, and low efficacy, which lead to high usage volumes and high residues. Using nanotechnology to significantly reduce pesticide microparticle size, improve formulation performance, and reduce pesticide usage can solve the above problems, making pesticide application have a smaller impact on the ecological environment and human health.

Most pesticides are insoluble in water but soluble in organic solvents. For this type of pesticide, the strategy to reduce microparticle size is to dissolve it in a certain solvent or composite solvent to form a monomolecular dispersed solution, and then use different methods to prepare this solution into nano micelles, nano crystals, nano spheres, nano capsules, nano gels, and various nano carriers.

However, for pesticides containing polyvalent metal ions that are insoluble in both water and organic solvents, their application in nano-form is limited. Copper oxychloride and zineb belong to this category. Under current technical levels, using traditional mechanical crushing and ultrafine grinding processes cannot fully achieve nanoscale dimensions, much less sizes below 100 nm. Therefore, preparing pesticide varieties like copper oxychloride and zineb, either individually or compounded, into transparent suspension dispersions with a microparticle size of less than 100 nm is a globally challenging problem.

### 2. Innovations of the Present Invention

The present invention uses copper chloride and a water-soluble alkali as reactants to form copper oxychloride, and Amobam and zinc salts as reactants to form zineb. By determining the molecular ratios of the reactants, the type and dosage of the polymeric surfactant (dispersant), and appropriate reaction conditions (addition method and speed of reactants, stirring speed, temperature, pH, etc.), and by utilizing the pesticide water dilution process, it prepares a clear, stable copper oxychloride/zineb nano-suspension dispersion of a certain concentration. This nano-dispersion can be directly used for crop disease control spraying operations.

The innovations of the present invention are as follows:
(1) Innovatively prepared a copper oxychloride zineb nano-suspension dispersion. The microparticle size of the copper oxychloride and zineb differs from all traditional micro-scale compounded formulations; its microparticles are less than 100 nm, thus possessing clear innovation. The innovative approach to obtaining this nano-suspension dispersion is: the two groups of chosen reactants are both water-soluble and divided into two components. Once the aqueous solutions of the two components come into contact, since it is an ionic reaction, the reaction rate is extremely fast, instantly generating copper oxychloride and zineb. Copper oxychloride and zineb have extremely low water solubility, and as they nucleate and crystals grow, they tend to precipitate from the water. The present invention takes two measures to prevent precipitation: First, prior to the reaction, an appropriately selected water-soluble polymeric surfactant (dispersant) of suitable quantity is added to the aqueous dispersion system, forming random coils in the aqueous solution; Second, it selects appropriate reaction conditions, including reactant concentration, suitable addition methods and speeds, suitable stirring speeds, and proper pH, to control product generation, nucleation, and crystal growth speeds. Thus, when the generated product crystal size is very small, under stirring, it is evenly dispersed into the random coils formed by the polymeric dispersant in the water. The hindrance from the random coil molecular network reduces the chances of the generated product crystals colliding and continuing to grow, thereby playing a dispersing, suspending, and stabilizing role for the generated product nano crystals. This is the microscopic mechanism for obtaining the copper oxychloride/zineb nano-suspension dispersion. If the copper oxychloride nano crystals are small enough-less than 100 nm-then according to colloidal solution theory, the copper oxychloride/zineb nano-suspension dispersion will exhibit a transparent state.
(2) Excellent performance of the copper oxychloride zineb nano-suspension dispersion. Its excellent performance is evident in its transparent appearance, indicating that the pesticide microparticles are fundamentally below the 100 nm scale. This not only meets national standards defining nano products but is also smaller than the microparticle sizes of all existing copper oxychloride and zineb compounded formulations. Once a pesticide variety is determined, the main factors determining its efficacy are the pesticide microparticle size and the performance of the additives. When the diluted pesticide has small microparticle sizes and high quantities during spraying, it can fully contact the target, allowing for reduced pesticide use while guaranteeing preventive efficacy. Additionally, the water-soluble polymeric surfactant used as a dispersant in the present invention can be selected from natural substances, their derivatives, and synthetic polymers. Out of environmental friendliness, biodegradable natural polymers and their derivatives are preferred, making the copper oxychloride/zineb nano-suspension dispersion not only highly efficient but also green and eco-friendly.
(3) The innovative preparation method of the copper oxychloride zineb nano-suspension dispersion eliminates the original technical material synthesis and formulation processing operations, as well as expensive facilities and equipment. Taking advantage of the pesticide water dilution process, the reactants preparing copper oxychloride and zineb are divided into three or two components. They are mixed via specific addition methods to obtain the target product—the copper oxychloride/zineb nano-suspension dispersion—in one step. This process bypasses the synthesis and purification processes and equipment for copper oxychloride and zineb technical materials, as well as the processing operations and equipment for the compounded formulations (wettable powders, suspension concentrates). It saves on synthesis and processing costs, makes the process simple and convenient to operate, and is environmentally friendly and energy-saving.
(4) The copper oxychloride zineb nano-suspension dispersion's use concentration can be adjusted based on crop types and disease control requirements. Using the copper oxychloride/zineb nano-suspension dispersion allows determining the dilution and spray water volumes based on crop type and growth stages. Then, depending on the severity of the disease, the spray concentration of the active ingredients of copper oxychloride/zineb can be determined. In this way, the dosage of copper oxychloride/zineb and the dosage of the polymeric dispersant can be established.

### 3. Technical Approach of the Present Invention

The reactants generating copper oxychloride can be copper chloride and an alkaline compound. Both copper chloride and alkalis (sodium hydroxide, potassium hydroxide, ammonium hydroxide) are water-soluble substances, dispersing as single molecules in water; when they meet, ion exchange reactions easily form copper oxychloride molecules. The reactants generating zineb can be dithiocarbamate salts (Nabam, potassium ethylenebisdithiocarbamate, Amobam) and zinc salts, all of which are water-soluble, dispersing as single molecules in water; when they meet, zineb molecules are also easily generated. This indicates that the formation processes for copper oxychloride and zineb, both containing metal ions, are similar.

The ingredients used above are divided into two or three components. The principle is that ingredients within the same component do not react with each other, ensuring simple packaging and convenient usage. Dithiocarbamate salts and alkaline compounds can form one component, copper chloride and zinc salts can form another component, and the required water-soluble polymeric additive can form the third component. For simplification, the water-soluble polymeric additive can be added to the first component, resulting in a two-component scheme.

Under a controllable stirring speed, an aqueous solution of one component (e.g., copper chloride, zinc salt) is added to the aqueous solution of the other component (e.g., Amobam, alkali, water-soluble polymeric additive, and water). By controlling the addition method and speed, as well as the stirring speed, the copper oxychloride/zineb nano-suspension dispersion can be generated.

In the system, copper oxychloride and zineb nano crystals, or mixed nano crystals, are generated simultaneously. When the crystal size is very small and quantities are low, they can temporarily disperse somewhat stably in the aqueous system. Because nano crystals are continuously generated, collisions, aggregation, and growth between crystals will occur. When the copper oxychloride and zineb crystal sizes are below 100 nm, the system is clear and transparent; when the size exceeds 100 nm and approaches the wavelength of visible light, the system starts to show opalescence and gradually becomes opaque. Combined with their own gravity, large-sized crystals will precipitate out. To prevent this, a water-soluble polymeric dispersant must be added to the system. Water-soluble polymeric dispersants are usually linear macromolecules, taking a random coil morphological structure when dissolved in water. A random coil is a loose spherical structure formed by the spontaneous coiling of the water-soluble polymer chain, with lipophilic/hydrophobic molecular chains gathered inside and hydrophilic polar groups on the outside. Initially generated copper oxychloride and zineb nano crystals, driven by mechanical stirring shear forces, diffuse into the interior of the random coils and are loaded. This isolates and prevents subsequently generated crystals from effectively colliding, growing, precipitating, and settling. Thus, the random coils formed by the water-soluble polymeric dispersant provide dispersion, suspension, stabilization, and protection for the copper oxychloride and zineb nano crystals. These random coils evenly disperse in the aqueous phase, and the nano crystals that have diffused into them are also evenly dispersed in the aqueous phase. When the crystal size is below 100 nanometers, the system appears clear and transparent, simulating water solubility.

It should be noted that during the generation of nano crystals, the component addition speed, stirring speed, and the diffusion speeds of reactants and products—which relate to the momentary reactant concentration and product dispersion level in the reaction zone—are crucial factors affecting nano crystal size. Regarding the addition speed, if the goal is generated nano crystals smaller than 100 nm, whether the system remains clear and transparent serves as the judgment criteria. The theoretical basis is that when the microparticle size is less than one-fourth the lower limit of the visible light wavelength (400~760 nm), no severe refraction or reflection occurs, so the system is transparent. Conversely, if the system is opalescent or opaque, it indicates the crystal size exceeds 100 nm.

To achieve this goal, the following points must be addressed:
(1) Controlling the formation speed and quantity of copper oxychloride and zineb crystal nuclei, as well as crystal growth speed, is key to obtaining microparticles smaller than 100 nm. This involves factors like the reactant concentration and diffusion speed in the reaction area, the type and dosage of the water-soluble polymeric dispersant, dilution water volume, and pH.
(2) Alkalinity Strength and Selection of Alkaline Compounds. The generation of copper oxychloride is a reaction between a salt and an alkali. The alkali used in traditional copper oxychloride preparation is slaked lime (calcium hydroxide). Although its alkalinity is relatively weak, its water solubility is poor, and its particles are large, making it difficult to separate and control from the even less water-soluble copper oxychloride generated in the system, ultimately forming a precipitate of large microparticles. Besides calcium hydroxide, sodium hydroxide, potassium hydroxide, and ammonium hydroxide can be used. The first two are strong alkalis, reacting rapidly with copper chloride and are harder to control. Ammonium hydroxide is a relatively weak alkali, reacting slower with copper chloride than the first two, leading to a relatively slower generation rate of copper oxychloride. Based on controlling the generation rate, nucleation, and crystal growth of copper oxychloride, ammonium hydroxide is the preferred alkaline compound.
(3) Selection of the Type and Dosage of Water-Soluble Polymeric Additive. Copper chloride reacts with alkalis to form copper oxychloride, and Amobam reacts with zinc salts to form zineb. Because the products are insoluble in water, molecular aggregation inevitably occurs in the water, forming crystal nuclei that continuously grow and eventually precipitate out. The present invention aims to control the crystal sizes of generated copper oxychloride and zineb to no larger than 100 nm. To prevent generated crystal nuclei from growing further, keeping them suspended, dispersed, and stable, a water-soluble polymeric dispersant must be added to the system. With hydrophilic groups, water-soluble polymeric dispersants can dissolve in water to become colloidal solutions. The viscosity of colloidal solutions is much greater than that of small-molecule surfactants at the same concentration. The high viscosity of water-soluble polymer solutions is due to their morphological structure in water differing from small molecules. Due to their large molecular weights and long molecular chains, water-soluble polymers dissolve in water not as straight chains, but as random coil morphological structures. These random coils disperse in water in a molecular dissolved state, ranging from a few nanometers to tens, hundreds of nanometers, or more, depending primarily on their molecular weight. These random coils provide suspension for the nano crystals generated in the solution; the principle is that random coils possess loose spatial structures, and under stirring, reaction-generated copper oxychloride and zineb crystals enter them, providing suspension, dispersion, stabilization, and blocking of crystal aggregation, preventing further crystal growth.
   By type, water-soluble polymers include anionic, cationic, zwitterionic, and non-ionic types; by origin, there are natural polymers and their derivatives, and synthetic polymers. The type and amount of water-soluble polymeric dispersant selected are determined through experimentation.
(4) The mixing speed of the two component solutions (i.e., the addition speed of one component) must not be too fast. If added too quickly, the two components disperse unevenly, leading to excessively high local reactant concentrations, which rapidly generates crystals, potentially causing aggregation between nano crystals, rapidly increasing crystal size. If opalescence appears in the system, it indicates the crystal size has already exceeded 100 nm. Thus, the addition speed of the component should be based on keeping the system continually transparent.
(5) The system's stirring speed should be appropriately increased. The stirring speed relates to the generation and dispersion speed of nano crystals in the aqueous phase. Sufficient stirring leads to fast diffusion, helping disperse reactant concentrations in the reaction area, slowing the reaction speed, and allowing rapidly formed nano crystals to disperse, retaining small crystal sizes and preventing aggregation and rapid growth. Stirring speed must correspond with component addition speed, also ensuring the system remains continuously transparent.

### Terminology Explanations

Dispersion System: Dispersing one or more substances into another substance constitutes a dispersion system. The substance being dispersed in a dispersion system is called the dispersed phase, and the other substance is called the dispersion medium. Based on the dispersed phase particle size, dispersion systems are divided into: Molecular (ionic) dispersion systems (particle size <1 nm); Colloidal dispersion systems (1 nm<particle size <100 nm).

Colloids and Sols: A colloid is a state where matter exists at a certain degree of dispersion, rather than an inherent state of a specific type of substance. Many normally insoluble substances can be dispersed in a medium under appropriate conditions to form what looks like a uniform solution, appearing no different from an ordinary true solution on the outside, but judging from aspects like diffusion speed and osmotic ability, they belong to the realm of colloidal substances, referred to as Sols.

Classification of Colloidal Solutions: Based on the stability of the colloidal solution and the structure of the colloidal particles, they are divided into: \textcircled{1} Lyophobic sols, abbreviated as Sols, which are formed by poorly soluble substances dispersed in a dispersion medium. The particles within are composed of varying numbers of molecules, possessing large phase interfaces and apparent free energy, are highly unstable, very easily destroyed and coagulate, cannot recover to their original state, and represent thermodynamically unstable and irreversible systems. \textcircled{2} Macromolecular compound solutions, whose molecular sizes have reached the colloidal range, possess colloidal properties, but are true solutions formed by molecules; they are thermodynamically stable and reversible systems, also known as Lyophilic sols.

Tyndall Effect: The so-called Tyndall effect refers to when a beam of light passes through a colloid, a bright “pathway” can be observed in the colloid from the direction perpendicular to the incident light. This phenomenon is also called the Tyndall effect. The essence of the Tyndall effect is a scattering phenomenon when light travels through a colloid. This occurs mainly because colloidal particle sizes are 1~100 nm. When visible light passes through a colloid, noticeable scattering happens, whereas a true solution's scattering effect on light is very weak. Therefore, colloids have a clear Tyndall effect, while molecularly dispersed true solutions have almost none, making the Tyndall effect a common way to distinguish between colloidal and true solutions.

Further explanation of the Tyndall effect is that when propagating light illuminates the particles in a solution, if the particles are larger than the incident light wavelength (400 nm~740 nm) or multiples thereof, distinct light reflection occurs; if particles are smaller than the incident light wavelength, light scattering occurs, seen as light waves radiating outwards around the microparticles. This radiating light is called scattered light or opalescence. The Tyndall effect is essentially a light scattering or opalescence phenomenon. Because true solution particle radii generally don't exceed 1 nm, and colloidal particles are between solution solute particles and suspension particles (size 1~100 nm, less than one-fourth the visible light wavelength's lower limit), visible light passing through a colloid produces significant scattering. For true solution molecules or ions, which are even smaller, scattered light intensity significantly weakens as scattering particle volume decreases; thus, true solutions have very weak light scattering. Moreover, scattered light intensity increases as particle concentration in the dispersion system increases. This leads to the judgment: when an observed solution is clear and transparent, the microparticle size is below 100 nm, and the Tyndall effect can occur; when the solution shows opalescence or increasingly heavy opalescence, it indicates particle sizes exceed 100 nm and are tending to grow larger; when the solution is turbid or opaque, microparticle sizes have grown to the micrometer level or above.

System: The so-called system refers to the system where alkalis react with copper chloride to form copper oxychloride, and Amobam reacts with zinc salts to form zineb, under the premise of controlling the addition method and speed, and stirring speed when preparing transparent copper oxychloride/zineb nano-suspension dispersions. The system is composed of copper chloride, alkaline compounds, Amobam, zinc salts, polymeric additives, and water.

Component: The so-called component refers to a composition containing one or more ingredients. In principle, any single ingredient used in the present invention can form a component on its own, but considering packaging, transportation, and convenience of use, the ingredients should be simplified into combinations. The principles are: \textcircled{1} ingredients do not react with each other; \textcircled{2} the number of components formed by the ingredients should not be too large.

Ingredient: The so-called ingredient refers to the raw materials used in this invention, including water-soluble copper chloride, alkaline compounds, dithiocarbamate salts, zinc salts, water-soluble polymeric additives, and water.

Polymeric Additive: Also known as polymeric surfactants or polymeric aids, refers to macromolecular compounds containing hydrophilic groups or hydrophobic backbones capable of dissolving in water. Because polymeric additives can provide dispersion, suspension, emulsification, and stabilization effects, they are also referred to based on their primary function as polymeric dispersants, polymeric suspending agents, polymeric emulsifiers, etc. Based on group properties, polymeric surfactants can be classified into non-ionic, anionic, cationic, and zwitterionic polymeric additives.

Water-Soluble Polymeric Dispersant: Also known as a water-soluble polymeric additive, refers to a macromolecular compound soluble in water. Water-soluble polymers, acting as surfactants, have many functions. When its primary function is dispersing other water-insoluble substances in water, it is called a water-soluble polymeric dispersant.

Precursor: The so-called precursor refers to the parent substance used to generate the target product. Here, the target products are copper oxychloride and zineb, and the precursors are copper chloride and Amobam, respectively.

Microparticle Size: Also known as microparticle dimension, refers to the size of the copper oxychloride and zineb microparticles generated in the system. This microparticle is usually a crystal grain, and does not specifically refer to the microscopic morphological structure of the grain.

Sub-100 Nanometer Level: This is a statistically significant classification of the pesticide microparticle size within the system. All microparticle sizes in the system exhibit a statistical distribution. The sub-100 nanometer level dispersion mentioned in the present invention means that at least 80% of the microparticles have a size smaller than this value. Microparticles larger than 100 nanometers account for only a small fraction.

Effective Stirring Speed: The so-called effective stirring speed means that under a certain addition method, when one component is added to another, through stirring at no less than the effective stirring speed, the nano crystals generated in the system can be dispersed in a timely manner without crystal growth and aggregation occurring, preventing the crystal size from growing to the multi-hundred nanometer level. The resulting system liquid presenting a transparent state is the hallmark of effective stirring.

Effective Stirring: The method and speed of adding components and stirring have a crucial impact on the resulting system liquid. Stirring methods include mechanical stirring, multi-point mechanical stirring, manual stirring, and multi-point manual stirring. Faster stirring speeds favor producing good results. If the resulting system liquid exhibits a transparent state, it is considered effective stirring. Conversely, it is considered ineffective stirring.

Pre-Stirring: When one component (the additive component) is added to another component (the base component), the relative speed of contact between the two impacts whether the nano crystals generated in the system can be dispersed in a timely manner. Pre-stirring prior to the addition of the additive component: meaning stirring the base component in advance so its rotation reaches a certain speed, can produce a good dispersion effect. Normally, the rotational speed of pre-stirring should reach or approximate the effective stirring speed.

Addition Method: The so-called addition method involves the sequence of mixing different components with water, combining them into two components. One of the two components is added to the other, or vice versa. Addition methods also include continuous addition, intermittent addition, fine stream addition, dropwise addition, spray addition, as well as addition at a fixed position or moving position. The addition method should aim for mixing and dispersion as quickly as possible.

Addition Speed: After determining the addition method, control the addition amount of the components with the goal of achieving effective stirring.

One of the objectives of the present invention is to overcome the deficiencies of existing technologies and provide a new idea and method. It utilizes the process of diluting pesticide formulations with water for spraying to facilitate the reaction of copper chloride and alkali to form copper oxychloride, and Amobam and zinc salts to form zineb, thereby providing a clear, visually water-soluble copper oxychloride/zineb nano-suspension dispersion that can be used directly for spraying.

The copper oxychloride/zineb nano-suspension dispersion of the present invention, loaded into pesticide spraying equipment, can be used for spraying operations. It is mainly used to prevent and control: apple alternaria leaf spot, anthracnose, ring rot, fire blight, etc. Citrus canker (bacterial), anthracnose, scab, etc. Pear scab, rust, pear fire blight, etc. Cucumber downy mildew, bacterial angular leaf spot, etc. Tomato early blight, late blight, bacterial canker, etc. Eggplant Phytophthora blight, Verticillium wilt, bacterial wilt, etc. Wheat head blight, rust, bacterial leaf streak, etc. Rice blast, sheath blight, stripe rust, bacterial leaf blight, etc. Corn northern leaf blight, southern leaf blight, stalk rot, etc.

The copper oxychloride/zineb nano-suspension dispersion of the present invention refers to a sub-100 nanometer level copper oxychloride and zineb suspension dispersion; the sub-100 nanometer level copper oxychloride/zineb nano-suspension dispersion is formed by diluting with water and mixing at least two components:
Component A: An aqueous solution composed of the precursor Amobam, alkaline compound, water-soluble polymeric dispersant, and water;
Component B: Precursor copper chloride, zinc salt solids, or copper chloride, zinc salt aqueous solution.

Component B can be further supplemented with water-soluble polymeric dispersant and water to form an aqueous solution.

Component A and Component B, under conditions of pre-stirring and effective stirring, generate copper oxychloride and zineb microparticles that are dispersed within a random coil morphological structure formed by the water-soluble polymeric dispersant dissolved in water.

The water-soluble polymeric dispersant is a natural polymer and its derivative surfactant, or a synthetic polymer surfactant.

The water-soluble polymeric dispersant can be selected from (at least one) water-soluble natural polymers and their derivatives, including starch, cellulose, guar gum, chitosan and their derivatives; fatty, fatty-aryl, fatty-phenol, aryl-phenol, and oleyl polyoxyethylene ethers; fatty polyether sulfates, sulfonates; Tween, alkyl polyglycosides, etc. It can also be selected from water-soluble synthetic polymers: polyvinylpyrrolidone (PVP), polyvinyl alcohol (PVA), sodium polyacrylate (PAA), polystyrene-maleate, etc., polyoxyethylene-polyoxypropylene-polyoxyethylene block copolymers. Water-soluble natural polymers and their derivatives are preferred.

The ratio of the dosage of the water-soluble polymeric additive to the volume of dilution water is no greater than 1:1000; preferably no greater than 1:800; more preferably no greater than 1:600.

The alkaline compound includes at least one of sodium hydroxide, potassium hydroxide, and ammonium hydroxide. Ammonium hydroxide is preferred.

Further, the sub-100 nanometer level copper oxychloride nano-suspension dispersion features an hours-level stability period.

### Sub-100 nm Level Suspension

To improve the efficacy of the nanoscale copper oxychloride/zineb, the present invention needs to reduce its microparticle size as much as possible. The original intention of researching nano-pesticides is to improve pesticide efficacy and reduce usage. Traditional pesticide formulations usually have microparticle sizes at the micrometer level. Reducing them to corresponding nanoscale dimensions spans three orders of magnitude. When reduced by different orders of magnitude, the number of microparticles increases differently. For example, reducing a traditional formulation's typical microparticle size from 2 μm to 200 nm, 20 nm, and 2 nm theoretically increases the particle count by 1000 (10³), 1 million (10⁶), and 1 billion (109) times, respectively. This shows that different reductions in microparticle size lead to different increases in particle count and differences in exerted efficacy. Therefore, to improve nano-pesticide efficacy, one should reduce its microparticle size as much as possible.

To further improve the efficacy of nanoscale copper oxychloride/zineb, the present invention aims to reduce its microparticle size below 100 nm. This is based on two aspects. First, sub-100 nm size is the defining minimum dimension a nanomaterial must have in at least one dimension. Second, when pesticide microparticles are between 1~100 nm, the formulation belongs to a colloidal solution, is visually water-soluble, clear, and transparent. A beam of light shining through the solution shows a clearly defined light path, fitting the description of the “Tyndall” effect.

### Concentration of the Copper Oxychloride/Zineb Nano-Suspension Dispersion

The concentration of the copper oxychloride/zineb nano-suspension dispersion of the present invention is affected by the active ingredient dosage and dilution water volume. Taking the traditional copper oxychloride/zineb compounded wettable powder as an example for controlling citrus canker, a reported active ingredient dosage is 185/75 grams/mu (1 mu= 1/15 hectare), with a normal water volume of 150 kg/mu. In this case, the dilution concentrations of copper oxychloride and zineb are 0.12% and 0.05%, respectively. Because the nano-suspension dispersion of the present invention has a small microparticle size and high efficacy, assuming a dosage reduction of about 30%, the actual dosage is approximately 130/52 grams/mu, and the concentrations of copper oxychloride/zineb in the nano-suspension dilution are about 0.087% and 0.035%, respectively.

### Stability Period

The copper oxychloride/zineb nano-suspension dispersion prepared by the present invention is a solution that is transparent in appearance and visually water-soluble, but it inherently lacks thermodynamic stability. Therefore, the time the nano-suspension dispersion maintains its transparent state is not indefinite but has a stability period. Considering the operational characteristics of spraying, after the nano copper oxychloride suspension dispersion is prepared, the required operation time should be at least over 1 hour. This way, the length of the stability period can be measured in hours. Thus, the present invention proposes the concept of a “stability period” for sub-100 nm nanoscale copper oxychloride suspension dispersions. That is, the sub-100 nm level copper oxychloride nano-suspension dispersion prepared by the present invention must complete the spraying operation while the solution remains transparent, and the stability period should reach at least 1 hour.

From an application perspective, the stability period can be further divided into 4 time frames: within 1 hour, 1-5 hours, 5~10 hours, and over 10 hours.

Completing the spraying operation within 1 hour indicates that the nano copper oxychloride/zineb suspension remains transparent, guaranteeing microparticle sizes are still below 100 nm.

By direct observation, changes in the transparent state and microparticle size of the nanoscale copper oxychloride/zineb suspension can be judged. During the stability period, the suspension remains transparent, and microparticle size is below 100 nm. When the suspension becomes unstable, opalescence first appears, indicating microparticle size is starting to grow. Weak opalescence indicates particles are starting to exceed 100 nm; gradually heavier opalescence indicates particle size has grown to hundreds of nanometers. The subsequent appearance of turbid precipitates indicates the microparticle size has increased to the micrometer or millimeter level.

The present invention's observation of the stability period phenomena for sub-100 nanometer level copper oxychloride suspension dispersions applies to various hours-level stability periods.

### Hours-Level Stability Period

Analyzing from the Perspective of Spraying Operations:

A stability time around 1 hour provides insufficient operational time for spraying tasks; a stability period over 10 hours has little significance for pesticide formulations. Even if the liquid is very stable, due to its low pesticide content and large volume capacity, it holds little practical utility for storage and transport.

Therefore, a stability time between 1 and 10 hours allows most pesticide equipment spraying operations to be comfortably completed within this timeframe.

The hours-level stability period mentioned in the present invention refers to a stability time between 1 and 10 hours.

For the hours-level stability period, further subdivisions can be made:
1-5 hours is the basic period for spraying operations; under most circumstances, spraying equipment can complete the task.
5~10 hours is the ample period for spraying operations; this accommodates spraying tasks delayed by special circumstances.

### Components and Additives of the Copper Oxychloride/Zineb Nano-Suspension Dispersion

Traditional single-agent and binary compounded formulations of copper oxychloride usually consist of just one component, which can be sprayed after water dilution, but their pesticide microparticle sizes are all above the micrometer level. To obtain a nanoscale copper oxychloride/zineb nano-suspension dispersion, the present invention adopts an at least two-component model, diluting and mixing with water according to a specific method to obtain a sub-100 nanometer level copper oxychloride/zineb nano-suspension dispersion.

The three-component model is explained below as an example.

### Basic Three-Component Scheme

The basic scheme for the sub-100 nanometer level copper oxychloride/zineb suspension of the present invention is a system generated by mixing and reacting three components. They are:

Component A: Composed of an aqueous solution of an alkaline compound and a dithiocarbamate salt. The dithiocarbamate salt is the precursor for zineb nano crystals.

For Component A, the alkaline compound is selected from at least one of sodium hydroxide, potassium hydroxide, and ammonium hydroxide, preferably an ammonium hydroxide aqueous solution (ammonia water). The dithiocarbamate salt is selected from at least one of Nabam, potassium ethylenebisdithiocarbamate, and Amobam, preferably Amobam.

Component B: Composed of copper chloride, zinc salt solids, or a zinc salt aqueous solution; these are the metal salts needed to generate copper oxychloride and zineb nano crystals.

For Component B, the zinc salt is selected from at least one of zinc sulfate, zinc acetate, zinc chloride, and zinc nitrate, preferably zinc sulfate. Component B can use solids or an aqueous solution.

Component C: Composed of at least one water-soluble surfactant or its aqueous solution; this is the additive that disperses, suspends, and stabilizes the generated copper oxychloride and zineb nano crystals.

Component C is an additive composed of water-soluble surfactants. The water-soluble surfactant can be selected from polymeric surfactants and small-molecule surfactants. Considering that polymeric surfactants offer better dispersion, suspension, and stabilization of crystals than small-molecule surfactants, polymeric surfactants are preferred.

The three components, under conditions of pre-stirring and effective stirring, generate copper oxychloride and zineb microparticles dispersed within the random coil morphological structure formed by the water-soluble polymeric dispersant dissolved in water.

The ratio of the amount of water-soluble polymeric surfactant to the dilution water volume is preferably no greater than 1:800.

The water-soluble polymeric surfactant mentioned in the present invention is selected from surfactants of natural substances and their derivatives, and synthetic polymers. Preferably selected from starch, cellulose, guar gum, chitosan and their derivatives; fatty, fatty-aryl, fatty-phenol, aryl-phenol, and oleyl polyoxyethylene ether derivatives; fatty polyether sulfates, sulfonates; Tween, alkyl polyglycosides, etc.

To simplify the components, making packaging, storage, transport, and dilution reaction operations simpler, the above three-component system can be merged into two components.

### Improved Two-Component Scheme

One of the improved schemes of the present invention: A sub-100 nanometer level copper oxychloride/zineb nano-suspension dispersion, featuring an hours-level stability period, is a system generated by mixing and reacting two components. They are:

Component A: An aqueous solution composed of ammonium hydroxide, Amobam, a water-soluble polymeric surfactant, and water. This is composed of the alkaline compound needed to generate sub-100 nanometer copper oxychloride, the precursor for generating zineb, the water-soluble polymeric surfactant providing dispersion, suspension, and stabilization, and water.

Component B: Composed of a mixed metal salt solid or its aqueous solution containing copper chloride (needed for generating copper oxychloride) and zinc sulfate (needed for generating zineb).

This improved scheme allocates the used water-soluble polymeric surfactant into Component A and Component B. It can be considered that Component A in the two-component scheme is equivalent to “Component A+Component C” in the three-component scheme.

### Reaction Equations and Proportions for Generating Copper Oxychloride and Zineb

The raw materials needed to generate copper oxychloride are copper chloride and ammonium hydroxide. The commonly accepted reaction equation below can determine the proportions and ideal dosages of products and reactants:

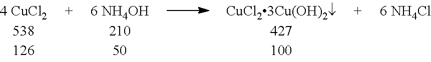

That is, generating 100 grams mass of copper oxychloride:copper chloride:ammonia water=100:126:50.

For generating zineb by choosing Amobam as the precursor and zinc sulfate as the zinc salt. Since zinc ions have coordination capabilities, the generated zineb structure involves two dithiocarbamate groups combining with one zinc ion. The reaction equation is:

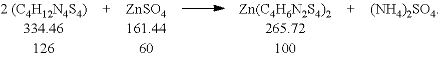

That is, generating 100 grams mass of zineb:Amobam:zinc sulfate=100:126:60.

### Water-Soluble Polymeric Dispersant (Additive)

(1) The transparent liquid of the copper oxychloride/zineb nano-suspension dispersion is the directly usable copper oxychloride/zineb compounded suspension. In this liquid, with the addition of a dispersing water-soluble polymeric additive, the generated copper oxychloride and zineb are suspended and dispersed as nano-sized microparticles in a random coil morphological structure formed by the polymeric additive dissolved in water. Since the microparticle size is less than 100 nanometers, it becomes a transparent, visually water-soluble copper oxychloride/zineb nano-suspension dispersion.
(2) The water-soluble polymeric additive with dispersion capabilities is a critical constituent affecting the generated copper oxychloride and zineb nano crystal sizes during the two-component dilution mixing, as well as whether they can uniformly disperse and stably suspend.
(3) Water-soluble polymeric additives are also polymeric surfactants, usually referring to substances with relatively large molecular weights that have surface activity. Compared to small-molecule surfactants, polymeric surfactants have a relatively weaker ability to lower surface tension but possess other special properties, such as dispersion, suspension, emulsification, and increasing viscosity. Classified by origin, water-soluble polymeric surfactants can be divided into natural polymers and their derivatives, and synthetic polymers. Water-soluble polymeric surfactants feature hydrophobic chain structures and hydrophilic functional groups. These groups might be end groups or side groups, such as hydroxyl, carboxyl, carboxymethyl, sulfonate, sulfate, phosphate, amino groups, etc., hence they are all water-soluble polymers. Water-soluble natural polymers and their derivatives include starch, cellulose and their derivatives, carboxymethyl chitosan, modified guar gum, tea saponin, etc. Water-soluble synthetic polymers include polyvinylpyrrolidone, polyvinyl alcohol, sodium polyacrylate, polyacrylamide, polystyrene-maleic anhydride copolymers, etc. Since the main chains of water-soluble synthetic polymers are mostly carbon chains and difficult to biodegrade, considering environmental friendliness, one should prioritize water-soluble natural polymers and their derivatives to minimize the impact on the ecological environment.
(4) The reason the present invention selects polymeric additives is to utilize the dispersion and suspension effects provided by water-soluble polymers in aqueous solutions. A water-soluble polymer with a relative molecular weight of tens of thousands, hundreds of thousands, or more, typically has a linear macromolecular chain structure that can dissolve in water. When a linear polymer dissolves in water, its aspect ratio is very large. Due to the chain's flexibility, it does not exist as a straight chain but in a coiled state, exhibiting a “random coil” morphological structure. The hydrophilic groups in the random coil face the aqueous phase, while the lipophilic chain structure coils within the interior of the random coil. The size of the random coil depends on the relative molecular weight of the polymeric additive, its concentration, and the polymer chain structure. A larger molecular weight results in a larger volume for the random coil formed by a single molecule. The more flexible the polymer chain, the easier it rotates internally, the more extended it is in the solvent, and the larger the random coil volume. When the water-soluble polymer concentration is higher, random coils formed by different molecules aggregate, forming larger micelles. Generally, when the molecular weight of the water-soluble polymer is in the tens of thousands or hundreds of thousands, the size of the generated random coil ranges from several to tens or hundreds of nanometers. If pesticide nano crystals are generated in the system, under stirring shear forces, they enter the random coils. When pesticide nano crystals are small, the interior of the random coils can disperse many nano crystals. Therefore, water-soluble polymeric additives can disperse and stabilize the generated nano crystals. Traditional pesticide suspension concentrates also use this principle, but their pesticide microparticles are micrometer-sized, relatively large, hence suspensions are generally opaque. Because the microparticles have significant gravity, there are significant stability risks. When the pesticide microparticle size is reduced by 2 to 3 orders of magnitude, the gravitational effect is much smaller; the same water-soluble polymeric surfactant can achieve a nano-suspension dispersion with a longer stability time, realizing visual water solubility and transparent appearance.
(5) The copper oxychloride/zineb nano-suspension dispersant is directly generated by the reaction of copper chloride and ammonium hydroxide, and Amobam and zinc sulfate during the water dilution process prior to use. The dosage of the water-soluble polymeric additive relates to the amount of copper oxychloride and zineb generated in the system and the dilution water volume. For example, when the copper oxychloride/zineb active ingredient dosage is 100/40 grams/mu, and the spray water volume is 100 kg/mu, the dilution concentration is 1~0.4 grams/kg, which is at spray concentration. By controlling the water-soluble polymeric additive dosage, the stability of the copper oxychloride/zineb nano-suspension dispersion can be adjusted. The concentration of the water-soluble polymeric additive should be no less than 0.2%.
(6) The copper oxychloride/zineb nano-suspension is formed directly during the water dilution process before spraying application. It directly mixes the two components according to a certain concentration and mixing method to obtain the target liquid. This scheme saves the synthesis and purification process of preparing copper oxychloride and zineb technical materials at the pesticide technical plant, and also bypasses the multi-step physical processing used at the formulation plant to process the technical materials into traditional compounded wettable powder formulations. The solution proposed by the present invention can be directly applied to the plant protection phase of agricultural production. The process is clearly environmentally friendly and energy-saving, significantly reducing production costs and enhancing efficacy, while notably reducing pesticide usage to achieve a reduce-volume and increase-efficiency effect.

### The Key Technologies of the Present Invention Involve the Following Aspects:

1. Reaction of Copper Chloride with Alkali and pH Control

Copper chloride (CuCl₂) can react with water-soluble alkalis (NaOH, KOH, and NH₄OH) to generate copper oxychloride. NaOH and KOH are strong alkalis, and NH₄OH is a weak alkali. Taking NH₄OH as an example, the reaction equation is:

4CuCl₂+6NH₄OH→CuCl₂·3Cu(OH)₂↓+6NH₄Cl

During preparation, controlling the pH is critically important for the reaction process and product. Copper chloride reacts with strong alkalis quickly, the system pH is high (12~14), so the copper oxychloride precipitate forms quickly. This is detrimental to obtaining sub-100 nm crystals. Because NH₄OH is a weak alkali, its reaction with CuCl₂ is gentle, the system pH is lower (7~8), and the copper oxychloride precipitate forms slower, which aids in controlling crystal growth rates. To obtain sub-100 nm copper oxychloride crystals, mild reaction conditions are favorable for control.

### 2. Control of Reaction Conditions for Preparing Nano Copper Oxychloride/Zineb

Preparing nanoscale copper oxychloride and zineb involves two separate reactions: the reaction of copper chloride and ammonia water, and the reaction of Amobam and zinc sulfate. Both are ionic reactions that occur easily. The key lies in obtaining nanoscale crystals, whose hallmark is a transparent dispersion. This involves the concentrations of the two component dilutions (related to water volume), the addition methods and speeds of the components, and stirring speeds. The reaction conditions to consider are:
(1) Component division and dilution water allocation. The principle for component division is that reactive ingredients must be separated to facilitate packaging and simple operations. The optimized two-component scheme features one component formed by an aqueous solution of precursor Amobam and ammonium hydroxide, and another component formed by copper chloride and zinc sulfate solids or their aqueous solution. The dilution water volume depends on the active ingredient concentration and should generally be greater than traditional pesticide formulations. The allocation ratio depends on the component addition order-whether Component A is added to Component B or vice versa. Generally, the volume allocated for the added component should be smaller than that for the receiving component to facilitate full mixing and shorten time.
(2) Reaction condition control. Slow dropwise addition: Under pre-stirring, slowly drip one component's diluted solution into the other. The addition method and speed are vital for controlling crystal size and uniformity. Effective stirring: ensure the reaction proceeds evenly, preventing localized high concentrations that cause crystal aggregation and growth.
(3) Control of nanoparticle growth and stabilization. The presence of a water-soluble polymeric dispersant in the system is extremely important. It disperses, suspends, and stabilizes the nano crystals generated by the system reaction, isolating and protecting them, reducing particle collision, and preventing aggregation and growth.

### 3. Selection of Water-Soluble Polymeric Dispersant

When preparing the copper oxychloride/zineb nano-dispersion, selecting appropriate types and quantities of water-soluble polymeric additives as dispersants to prevent precipitation and maintain transparency is a key technology of the present invention. These substances stabilize the nanoparticles, preventing aggregation and precipitation, thus sustaining the dispersion's transparency. The water-soluble polymeric additives selected for the present invention include:

Water-soluble natural polymers and their derivatives. Used as dispersants, these include starch, cellulose, guar gum, chitosan and their derivatives (e.g., carboxymethyl starch, carboxymethyl cellulose, lignosulfonates, carboxymethyl chitosan, modified guar gum); fatty acid derivatives (e.g., sodium dodecyl sulfate, sodium dodecyl polyether sulfate); polyoxyethylene ether derivatives involving various hydrophobic groups like fatty, fatty-aryl, fatty-phenol, aryl-phenol, and oleyl groups (e.g., Pereal series, OP series, Tween series, polyol series, ricinoleic acid series, alkyl polyglycosides, etc.).

Water-soluble synthetic polymers. These include polyvinylpyrrolidone (PVP), polyvinyl alcohol (PVA), polyacrylates (PAA), polyacrylamide, polystyrene-maleate, etc., polyoxyethylene-polyoxypropylene-polyoxyethylene block copolymers, amino silicone oil, etc.

When using these water-soluble polymeric dispersants, it is crucial to determine through experiments the most suitable types and dosages to achieve the best dispersion effect and solution transparency. Also, dispersant selection should consider the final application field's requirements, such as biodegradability and environmental impact. Therefore, biodegradable natural polymers and their derivative additives are prioritized. Notably, in most cases, it is necessary to use different dispersants in combination—i.e., composite additives—to achieve optimal results.

### Preparation Method of the Copper Oxychloride/Zineb Nano-Suspension Dispersion

The present invention adopts the following technical scheme, using the convenient two-component scheme as an example:

### 1). Composition and Preparation of the Two-Component Scheme

Component A: Composed of an alkaline compound (preferably ammonium hydroxide), a precursor (preferably Amobam), a selected water-soluble polymeric surfactant, and water. This is a mixed aqueous solution consisting of the alkaline compound needed for sub-100 nm copper oxychloride, the precursor for zineb, the water-soluble polymeric surfactant for dispersion/suspension/stabilization, and water.

Preparation of Component A: Since water-soluble polymeric additives are harder to dissolve in water than small molecules, it should be added to the appropriate amount of water first and stirred until dissolved. Then, the precursor and alkaline compound are added and stirred to dissolve, obtaining a transparent Component A aqueous solution.

Component B: Composed of mixed metal salts containing precursor copper chloride (for copper oxychloride) and zinc sulfate (for zineb). Component B can be a solid mixture or an aqueous solution mixed with water.

Preparation of Component B: If Component B is in solid form, simply mix the two metal salts. If in solution form, add the two metal salts of Component B to the appropriate amount of water, stir to dissolve, and obtain the transparent Component B aqueous solution.

### 2). Diluting Component A and Component B According to Allocated Water Ratios

Based on the dilution water volume, dilute Component A and Component B in two appropriately sized containers according to their allocated proportions. This produces the transparent diluted aqueous solutions for Component A and Component B, respectively.

### 3). Reaction of the Two Diluted Component Aqueous Solutions

Under pre-stirring, add the Component B diluted aqueous solution to the Component A diluted aqueous solution according to a specific addition method to conduct the reaction. In other words: pre-stir the Component A diluted solution first, and then under a stirring speed no less than the effective stirring speed, add the Component B diluted solution to the Component A diluted solution.

It can also be added in the reverse manner: pre-stir the Component B diluted solution first, and then under a stirring speed no less than the effective stirring speed, add the Component A diluted solution to the Component B diluted solution.

The generated copper oxychloride and zineb nano microparticles disperse into the random coil morphological structure formed by the water-soluble polymeric dispersant dissolved in water.

Addition methods include dropwise addition, fine stream addition, spray addition, intermittent addition, continuous dropwise addition, alternating continuous and intermittent addition, etc. Control the addition speed and stirring speed, observing that the reaction system remains consistently transparent until the aqueous solution of one component is fully added.

This yields the copper oxychloride/zineb nano-suspension dispersion. The dispersion appears transparent and visually water-soluble, directly usable for spraying crop diseases. Observe the time it takes for precipitation to appear in the transparent dispersion; this time interval represents the operational period for spraying.

### BRIEF DESCRIPTION OF DRAWINGS

FIG. 1: Flowchart for the preparation of the copper oxychloride/zineb nano-suspension dispersion (two components);

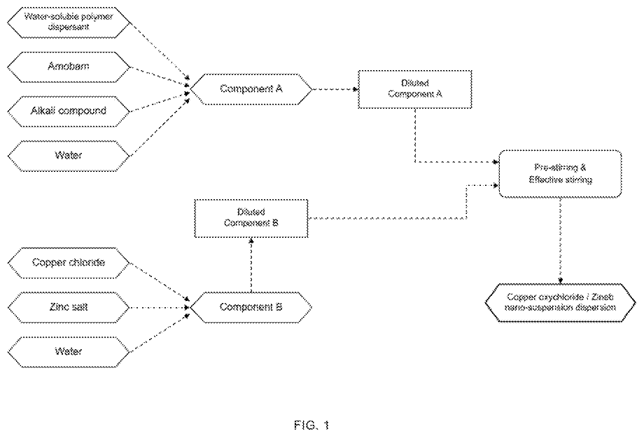

FIG. 2: Flowchart for the preparation of the copper oxychloride/zineb nano-suspension dispersion (three components).

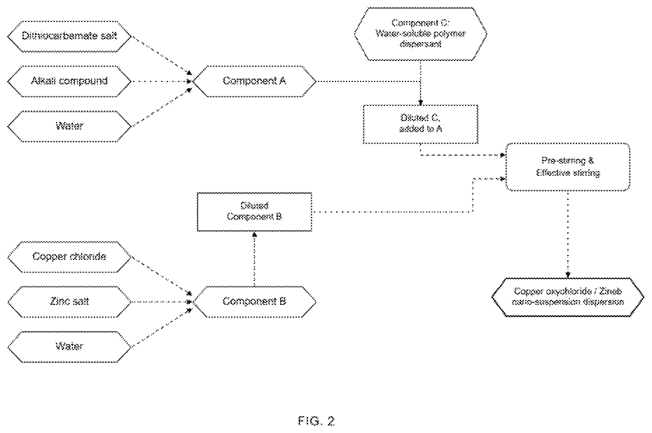

### EMBODIMENTS

### Example 1

The copper oxychloride/zineb nano-suspension dispersion can be used to control cucumber bacterial angular leaf spot. A reported dosage for the two active ingredients is 37/15 grams/mu, with a dilution water volume of 30 kg. Considering the high efficiency of nano-pesticides, the active ingredient dosage for copper oxychloride/zineb selected in this example is 30/12 grams/mu, with a dilution water volume of 30 kg/mu.

According to the mass ratios of the reactants in the following chemical equations:

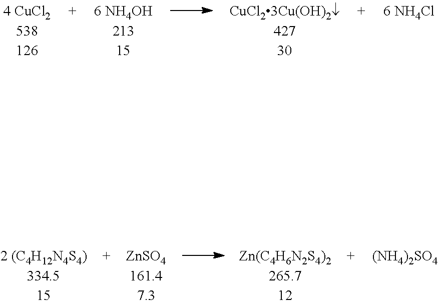

The compositional dosages for each component, proportional allocation of dilution water, and solution preparation methods are listed in the table below:

| Component | Composition | Mass (g) | Total (g) | Preparation |
|---|---|---|---|---|
| A | Amobam | 15 | 1000 | Disperse carboxymethyl |
| | Ammonia water | 54 | | cellulose in water, allow to |
| | (28%) | | | swell, then stir to dissolve. |
| | Carboxymethyl | 8 | | Add other additives, stir to |
| | cellulose | | | dissolve, then add Amobam |
| | Alkylaryl | 120 | | and ammonia water to obtain |
| | polyoxypropylene | | | the Component A aqueous |
| | polyoxyethylene | | | solution |
| | ether | | | |
| | Sodium alkyl | 100 | | |
| | ether sulfate | | | |
| | Water | 703 | | |
| B | Copper chloride | 38 | 45.3 | Component B is a solid |
| | Zinc sulfate | 7.3 | | mixture |
| | Dilution water | | 30 kg | Dilution ratio for Component |
| | volume | | | A and Component B: ⅚, ⅙ |

### Operating Method:

(1) In an appropriate container, add the ⅚ allocated water volume (25 kg), add Component A, and stir to dissolve to obtain a transparent Component A diluted aqueous solution.
(2) In another appropriate container, add the ⅙ allocated water volume (5 kg), add Component B, and stir to dissolve to obtain a transparent Component B diluted aqueous solution.
(3) Under pre-stirring, add the Component B diluted aqueous solution via continuous dropwise addition into the Component A diluted aqueous solution. Control the addition speed and stirring speed, maintaining the system consistently in a transparent state until the Component B dilution is completely added.

This yields a transparent copper oxychloride/zineb nano-suspension dispersion, directly usable for spraying cucumbers. Observe the stability time of the copper oxychloride/zineb nano-suspension dispersion. The stability time is 4 hours.

### Example 2

The copper oxychloride/zineb nano-suspension dispersion can be used to control tobacco wildfire. A reported dosage for the two active ingredients is 55/22 grams/mu, with a dilution water volume of 30~50 kg. Considering the high efficiency of nano-pesticides, the active ingredient dosage for copper oxychloride/zineb used in this example is 40/18 grams/mu, with a dilution water volume of 40 kg/mu.

According to the mass ratios of the reactants in the following chemical equations:

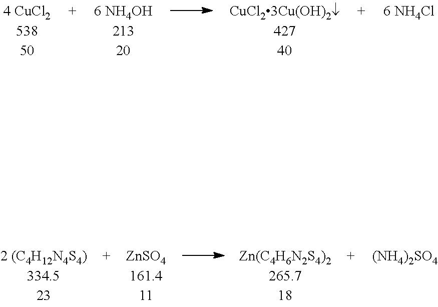

The compositional dosages for each component, proportional allocation of dilution water, and solution preparation methods are listed in the table below:

| Component | Composition | Mass (g) | Total (g) | Preparation |
|---|---|---|---|---|
| A | Amobam | 23 | 1000 | Disperse polyvinyl alcohol in |
| | Ammonia water | 72 | | water, allow to swell, then stir |
| | (28%) | | | to dissolve. Add other |
| | Polyvinyl alcohol | 30 | | additives, stir to dissolve, and |
| | Castor oil | 150 | | finally add Amobam and |
| | polyoxyethylene | | | ammonia water to obtain the |
| | ether | | | Component A aqueous |
| | Ammonium alkyl | 120 | | solution |
| | ether sulfate | | | |
| | Water | 608 | | |
| B | Copper chloride | 50 | 61 | Solid mixture |
| | Zinc sulfate | 11 | | |
| | Dilution water | | 40 kg | Dilution ratio for Component |
| | volume | | | A and Component B: ⅘, ⅕ |

### Operating Method:

(1) In an appropriate container, add the ⅘ allocated water volume (32 kg), add Component A, and stir to dissolve to obtain a transparent Component A diluted aqueous solution.
(2) In another appropriate container, add the ⅕ allocated water volume (8 kg), add Component B, and stir to dissolve to obtain a transparent Component B diluted aqueous solution.
(3) Under pre-stirring, add the Component B diluted aqueous solution into the Component A diluted aqueous solution using a fine stream addition method. Control the addition speed and stirring speed, maintaining the system consistently in a transparent state until the Component B dilution is completely added.

This yields a transparent copper oxychloride/zineb nano-suspension dispersion, directly usable for spraying tobacco. Observe the stability time of the copper oxychloride/zineb nano-suspension dispersion. The stability time is 5 hours.

### Example 3

The copper oxychloride/zineb nano-suspension dispersion can be used to control citrus tree canker. A reported dosage for the two active ingredients is 125/50 grams/mu, with a dilution water volume of 100~150 kg. Considering the high efficiency of nano-pesticides, the active ingredient dosage for copper oxychloride/zineb used in this example is 90/35 grams/mu, with a dilution water volume of 150 kg/mu.

According to the mass ratios of the reactants in the following chemical equations:

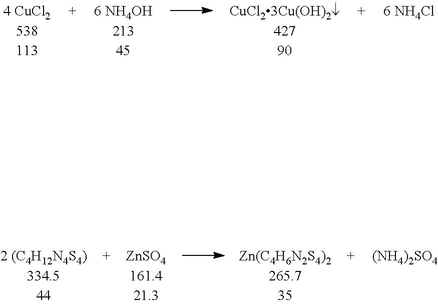

The compositional dosages for each component, proportional allocation of dilution water, and solution preparation methods are listed in the table below:

| Component | Composition | Mass (g) | Total (g) | Preparation |
|---|---|---|---|---|
| A | Amobam | 44 | 250 | Dissolve Amobam and ammonia |
| | Ammonia water | 161 | | water in water to obtain the |
| | (28%) | | | Component A aqueous solution |
| | Water | 45 | | |
| B | Copper chloride | 113 | 134.3 | Solid mixture |
| | Zinc sulfate | 21.3 | | |
| C | Alkylaryl | 150 | 500 | Viscous mixed liquid |
| | polyoxypropylene | | | |
| | polyoxyethylene | | | |
| | ether | | | |
| | Castor oil | 150 | | |
| | polyoxyethylene | | | |
| | ether | | | |
| | Ammonium alkyl | 200 | | |
| | ether sulfate | | | |
| | Dilution water | | 150 kg | Dilution ratio for “Component A + |
| | volume | | | Component C” and Component |
| | | | | B: 9/10, 1/10 |

### Operating Method:

(1) In an appropriate container, add the 9/10 allocated water volume (135 kg), add Component C, and stir to dissolve to obtain a transparent Component C diluted aqueous solution.
(2) Add Component A to the Component C diluted aqueous solution, stir and disperse, obtaining their “Component A+Component C” mixed diluted aqueous solution.
(3) In another appropriate container, add the 1/10 allocated water volume (15 kg), add Component B, and stir to dissolve to obtain a transparent Component B diluted aqueous solution.
(4) Under pre-stirring, add the Component B diluted aqueous solution to the “Component A+Component C” mixed diluted aqueous solution via continuous spray addition. Control the addition speed and stirring speed, maintaining the system consistently in a transparent state until the Component B dilution is completely added.

This yields a transparent copper oxychloride/zineb nano-suspension dispersion, directly usable for spraying citrus trees. Observe the stability time of the copper oxychloride/zineb nano-suspension dispersion. The stability time is 6 hours.

What is claimed is:

1. A copper oxychloride/zineb nano-suspension dispersion, wherein the copper oxychloride/zineb nano-suspension dispersion is a sub-100 nanometer level copper oxychloride/zineb nano-suspension dispersion formed by diluting with water and mixing two components:
Component A: an aqueous solution composed of Amobam (ammonium ethylenebisdithiocarbamate), an alkaline compound, a water-soluble polymeric dispersant, and water;
Component B: copper chloride, zinc salt solids, or an aqueous solution of zinc salts;
Component A and Component B, under conditions of pre-stirring and effective stirring, generate copper oxychloride microparticles that are dispersed within a random coil morphological structure formed by the water-soluble polymeric dispersant dissolved in water.

2. The copper oxychloride/zineb nano-suspension dispersion according to claim 1, wherein the water-soluble polymeric dispersant is a water-soluble natural polymer and its derivative surfactant, or a synthetic polymer surfactant.

3. The copper oxychloride/zineb nano-suspension dispersion according to claim 1, wherein the water-soluble polymeric dispersant is at least one of the following options:
water-soluble natural polymers and their derivatives, including starch, cellulose, guar gum, chitosan and their derivatives; fatty, fatty-aryl, fatty-phenol, aryl-phenol, and oleyl polyoxyethylene ethers; fatty polyether sulfates and sulfonates; Tween, alkyl polyglycosides;
or water-soluble synthetic polymers, such as polyvinylpyrrolidone, polyvinyl alcohol, sodium polyacrylate, polystyrene-maleate, etc., and polyoxyethylene-polyoxypropylene-polyoxyethylene block copolymers;
water-soluble natural polymers and their derivatives are preferred.

4. The copper oxychloride/zineb nano-suspension dispersion according to claim 1, wherein the copper oxychloride/zineb nano-suspension dispersion has an hours-level stability period.

5. The copper oxychloride/zineb nano-suspension dispersion according to claim 1, wherein the ratio of the amount of water-soluble polymeric dispersant to the amount of dilution water is no greater than 1:800.

6. A copper oxychloride/zineb nano-suspension dispersion, wherein the copper oxychloride/zineb nano-suspension dispersion is a sub-100 nanometer level copper oxychloride/zineb nano-suspension dispersion, generated by mixing and reacting a three-component system:
component A: composed of an aqueous solution of an alkaline compound and a dithiocarbamate salt;
Component B: composed of copper chloride, zinc salt solids, or an aqueous solution of zinc salts;
Component C: composed of at least one water-soluble polymeric dispersant, or its aqueous solution;
the three components, under conditions of pre-stirring and effective stirring, generate copper oxychloride microparticles that are dispersed within a random coil morphological structure formed by the water-soluble polymeric dispersant dissolved in water.

7. The copper oxychloride/zineb nano-suspension dispersion according to claim 6, wherein the zinc salt is selected from at least one of zinc sulfate, zinc acetate, zinc chloride, and zinc nitrate, with zinc sulfate being preferred.

8. The copper oxychloride/zineb nano-suspension dispersion according to claim 6, wherein the alkaline compound is selected from at least one of sodium hydroxide, potassium hydroxide, and ammonium hydroxide, with an ammonium hydroxide aqueous solution being preferred.

9. The copper oxychloride/zineb nano-suspension dispersion according to claim 6, wherein the dithiocarbamate salt is selected from at least one of Nabam (sodium ethylenebisdithiocarbamate), potassium ethylenebisdithiocarbamate, and Amobam, with Amobam being preferred.

10. The copper oxychloride/zineb nano-suspension dispersion according to claim 6, wherein the copper oxychloride/zineb nano-suspension dispersion has an hours-level stability period.

11. The copper oxychloride/zineb nano-suspension dispersion according to claim 6, wherein the water-soluble polymeric dispersant is a surfactant selected from natural substances and their derivatives, and synthetic polymers;
Preferably selected from starch, cellulose, guar gum, chitosan and their derivatives; fatty, fatty-aryl, fatty-phenol, aryl-phenol, and oleyl polyoxyethylene ethers; fatty polyether sulfates and sulfonates; Tween, and alkyl polyglycosides.

12. A preparation method for a copper oxychloride/zineb nano-suspension dispersion, wherein:
the diluted solution of Component A is pre-stirred first, and then under conditions where the stirring speed is no less than the effective stirring speed, the diluted solution of Component B is added to the diluted solution of Component A to form the copper oxychloride/zineb nano-suspension dispersion;
alternatively, the diluted solution of Component B is pre-stirred first, and then under conditions where the stirring speed is no less than the effective stirring speed, the diluted solution of Component A is added to the diluted solution of Component B to form the copper oxychloride/zineb nano-suspension dispersion;
Component A: an aqueous solution composed of Amobam, an alkaline compound, a water-soluble polymeric dispersant, and water;
Component B: copper chloride, zinc salt solids, or an aqueous solution of zinc salts;
the generated copper oxychloride microparticles are dispersed within a random coil morphological structure formed by the water-soluble polymeric dispersant dissolved in water.

13. The preparation method according to claim 12, wherein the addition method includes intermittent addition, continuous dropwise addition, or continuous or intermittent spray addition.
